(19) United States
(12) Patent Application Publication
(10) Pub. No.: US 2010/0027785 A1
(43) Pub. Date: Feb. 4, 2010

(54) DEVICE AND METHOD FOR SECURITY HANDSHAKING USING MIXED MEDIA

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: LASERCARD CORPORATION, Mountain View, CA (US)

(21) Appl. No.: 11/934,622

(22) Filed: Nov. 2, 2007

Related U.S. Application Data
(60) Provisional application No. 60/864,361, filed on Nov. 3, 2006.

(51) Int. Cl. H04L 9/30

(52) U.S. Cl. 380/44; 380/30

(57) ABSTRACT

A method and device for private/public key encryption using optical media. A key pair is generated, and the public key pair is stored on the optical media. The media is scanned and the optical media characteristics are used to hash stored information with the private key. The hashed version of the private key is then stored on the optical media. A read/write unit may subsequently de-hash the private key for encryption of data files.

### CROSS-REFERENCE TO RELATED APPLICATION

This application claims priority from U.S. provisional application No. 60/864,361, filed Nov. 3, 2006.

### TECHNICAL FIELD

The present invention relates to security access, more specifically to devices and methods for use of optical and electronic media for security handshaking applications. Security handshaking, in this application, is defined as to pieces of security information that must match in order to give access to other information, for example a password (secure information 1) and a database of passwords (secure information 2) that give access to other information (secure information 3). In this application the first piece of secure information is recorded on optical media and the second piece of secure information is recorded in electronic media.

### BACKGROUND OF THE INVENTION

Optical recording media provides a convenient and inexpensive means for storing data, an example of such a device is the credit card sized device sold by LaserCard Corporation (Mountain View, Calif.). In optical data storage, spots or other marks (which may be micro in scale but generally are about 2.5 microns) are marked under the surface of an optical data storage media, such as an optical data read/write unit. This data is then read by an optical reader. Data is encoded by variations of pit formation and spacing on the optical media, or by printing, such as lithographic or ink-jet printing. Unlike semiconductor memory, optical memory is inherently not digital in nature; rather, it is an analog optically readable representation of electronic digital data, which must be converted from its analog or optical form. This requires reading of the pits or spots or other marks on an optically contrasting background and conversion of the optical data into digital data.

Optical memory cards are used throughout the world to store data (for example, in medical identification cards for immigration, or driver identification cards, etc.) Security, such as encryption, is needed to protect such information from public disclosure. For some optical memory cards, the machine readable data is in the form of optically preformatted and recorded digitally encoded information, as described in ISO documents 11693 et al. Various other protection devices such as authentication schemes and public/private key pairs are also common.

The basic characteristics of public/private key pairs are that a mathematical algorithm is used to generate two related numbers, called key pairs. The working premise of Public Key Encryption (PKI) is that having access to the private key allows encryption of data that may only decoded with the related public key. The public key in turn validates that the message could only have come from the holder of the related private key. For optical media, the public key used to decode data may be stored on the optical media (e.g., on an optical card).

Key length (i.e., the number of digits used for each key) is often lengthened to increase security, by limiting brute force attempts at determining the private key number. Such attempts may simply generate sequential numbers until the correct key is identified. To prevent this from occurring, private keys are often designed to expire after a specified period of time; after which a new key is set. The advantage of the key set method is that if the private key is identified, only a limited set of data may be decrypted. For this reason, having a key set specific to an individual data storage device limits the amount of data that would be derived from obtaining the private key.

A public/private key pair requires that the private key be stored at a secure location where the key is only accessible by authorized users. The private key is used for decrypting a digital message or file. This means that at least at some point the private key is contained within some type of computer processor. The current industry standard for storing private keys include the following:
1) Storage of the key as a protected file on a computer hard drive.
2) Storing the private key in a special purpose add-on circuit board in a personal computer bus slot within which the key is stored in a protected semiconductor memory.
3) Storing the private key in an integrated circuit that has the processing power to encrypt or decrypt messages sent via the unsecured PC communication bus to external encryption chip.

One prior cryptographic system is seen in U.S. Pat. No. 6,871,278 to LaserCard Corporation, Mountain View, Calif., which discloses a transaction system for the use with passive data storage media such as optical memory cards, which uses secure protocols including digital certificates for communication between the read/write unit and the optical media. Additionally, LaserCard Corporation has produced devices that include an optical media read/write unit that also reads integrated circuits for holding electronically written data. Such secure protocols are also used for communication between the drive and host computer. The drive is physically secured with tamper resistant features and stores the cryptographic keys and firmware for executing the secure protocols. All messages including data or commands pass between the drive and the passive media are both encrypted and include at least one digital certificate for authenticating the media. Commonly asymmetric (i.e., public/private key) encryptions are used and keys may be derived from the authorized users password, personal identification number, or biometric data. The drive includes sensors to detect any attempted intrusions as well as a control unit that will responds if the situation of a security breach, for example, deleting critical information such as cryptographic keys and protocol code.

One present object outlined here is the invention of a system in which security handshaking information for authentication of a system user may be stored on an optical media without loss of security in a first instance and in electronic media in the second instance, i.e., a mixed media data pair for security handshaking.

### SUMMARY

One embodiment of the invention above includes a public/private encryption key pair and the generation of a security handshaking data pair that includes conversion of the private key into a hash code using the analog signal characteristics of an optical recording medium storage of the private key hash code onto the optical media. In this way, analog signal characteristics, which are essentially impossible to detect using microscope imaging techniques are used to provide a secure method for storage of the private key on the optical recording medium itself. The generation of the key pairs, and any subsequent use of the private key, can occur in an electronic state machine on a read write system, thereby completing security handshaking. The optical medium may be, for example, an optical card. The analog signal characteristics could include one or more different types of signal characteristics. In addition, the analog signal characteristics may be derived from one or more tracks or areas on the optical media. Such analog signal characteristics may be either native to the optical media or artificially created for the purpose of storage of the private key on the optical media.

In another embodiment, this is achieved through an optical data recording device that includes a number of tracks capable of storing optical data. A public encryption key is stored on a public track on the optical media. A hashed private key is stored on a private key track on the optical media. This hashed private key is a private key from a public/private key pair converted into a hash code using analog signal characteristics of the optical media storage device. The keys are compared in an electronic device that gives access if the keys match.

In another embodiment of the invention, a method to encrypt data includes adding a data file to an electronic read/write unit, inserting an optical recording medium device into the read/write unit, the optical device including a data track storing a hashed private key (that has been converted into a hash code using analog signal characteristics of the optical media). The hashed private key is read into an electronic state machine registers on the read/write unit. The read/write unit then reads the analog signal characteristics of the optical medium. These signal characteristics may include any of the signal characteristics noted above. The hashed private key is then converted into non-hashed form using the hash function and the analog media characteristics. This non-hashed private key may then be used as needed with an electronic access device.

### BRIEF DESCRIPTION OF THE DRAWINGS

FIG. 1 is a front view of an optical storage medium data card.

FIG. 2 is a flow chart for the steps of generating a public/private key pair and storing the secure private key on the optical medium.

FIG. 3 is a flow chart showing the steps of using the secure private key generated in the process shown in FIG. 2.

### DETAILED DESCRIPTION

The various embodiments described here illustrate a security handshaking access system with a private key from a public/private encryption pair to be stored in an optical storage media as a first of a security authentication data pair. This overcomes inherent limitations of optical media when used for PKI applications. As noted in the Background section, an optical medium stores data in the form of burned pits, holes, spots, or dots at varying relative spacings. The data content may be represented by a distance from one mark to the next, which may be read to mean a binary (i.e., one or zero). Other data encoding schemes may also be used. Such an optical medium has characteristic analog signal properties. These properties are specific to the analog medium and may be used to create a type of signature of the media. Such characteristics can appear seemingly random so that the ability to microscopically find such differences is quite difficult. In addition, these analog signal differences can be of many different types and may be found throughout the optical media.

Storage of the private key, which is intended to be used to decrypt the message stored within the same optical media, was not previously thought to be secure. This is because access to the key is necessary to decrypt the remaining message block. Therefore, the electronic read/write unit must at some point extract the key from the media surface. This exposes the key to possible identification by an unauthorized user. Once it is in binary form it is possible to reuse the private key within the host computer via standard algorithms. This security problem can be abated by restricting the decoding data in the decrypting microprocessor as part of the internal optical media control electronics. This can be considered a second or even a third piece of security information that protects the data from ever being transmitted across the peripheral data bus connecting the read/write unit to the host computer. However, once an encryption key has been reduced to electronic binary form in the microprocessor it is subject to the same potential security problems as been seen conventionally in integrated circuit chips or a hard drive; therefore, physical device protection is necessary.

This is achievable with either a “smart” card carrying an integrated circuit, or the various embodiments of the present invention. Only if a person has both the media device and a read/write unit, would it be possible to obtain both the public and private key. Various methods to preventing this occurring by unauthorized users include requiring a password or personal identification number, or the use of biometric data. These and other means may be used for identity verification.

In some of the present embodiments, the analog signal characteristics of the optical medium are used to convert the generated private key into a hash code. This private key hash code may be written into the optical recording medium, effectively creating a private key specific to the unique analog characteristics of a specific piece of the optical medium. The private key itself is never stored on the optical medium, only the hash version is stored on the medium itself.

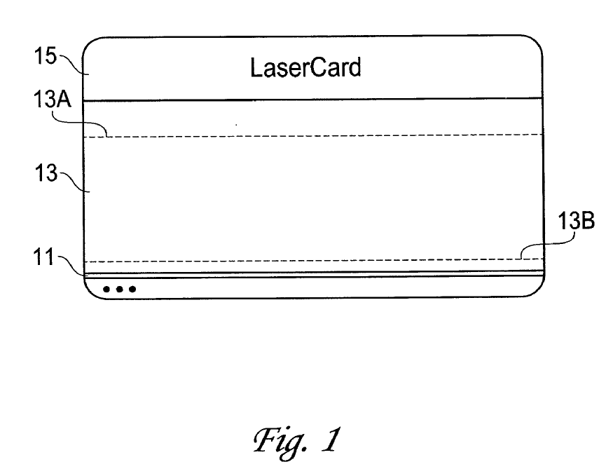

With reference to FIG. 1, an optical card is shown. This card may include a human readable section (15) and a magnetic strip (11). Between these two sections is an optical recording medium (13). This may include a section in which a non-encrypted public key is stored on a data track (13A). It may also include a hashed private key on another track (13B).

The steps for preparation of the optical recording medium are represented in the flow chart of FIG. 2. In the initial step 40, the optical media is inserted into a read/write unit. This read/write unit allows writing onto the tracks of the optical media. In step 42 the media is scanned to collect analog characteristics. These analog characteristics may either be native to the medium, or may be specific characteristics that are by design placed on the optical recording medium.

There are a significant number of characteristics for a given optical medium, which may be used individually, or in combination, to create a signature of the medium that is highly unique and recognizable in repeated scans. These individual characteristics allow for hashing with the private key to create a unique encryption key. This hashed private key may then be written onto the media. U.S. Pat. Nos. 5,694,471 and 6,675,153 hereby incorporated by reference, disclose relevant reader functions.

The types of media characteristics that can be used as the analog signal include 1. variation in recorded spot size, 2. variation in the medium reflectivity, 3. variation in bit jitter of the recorded pits, 4. variation in track lengths, 5. variation in the tracking error signal, 6. variation in the preformatted signal contrast, 7. variations in the bit error rate and data packets, 8. variation in media skew, 9. variation in media focus error signal, 10. variation in data track entering within the tracks, 11. occurrence of known defects within the tracks. Any of these characteristics, or other analog media characteristics, may be determined by the media reader. These represent the types of analog signature characteristics that are generated in step 42.

A single analog signal characteristic may be used, or some combination of analog signal characteristic may be used. In addition, the analog characteristic of the media may be location specific, for a specific area of the card, or as variation in pit size on certain tracks. By combining both multiple analog characteristics with location specific measuring of these characteristics, manual determination of the characteristic is essentially not possible.

In step 44, a public/private key pair is generated by an electronic state machine. In step 46 the public key can be written onto a public key track on the optical recording medium. In FIG. 1 this was shown as track 13A. This track is in the clear and is not hashed or otherwise coded. The PKI encryption method allows this key to be publicly known. In step 48, the private key is converted into an optical medium private key hash code. The hashed version of the private key is then written onto the optical medium. Because the analog signal characteristics are used for generating the private key hash code, the private key hash code is both specific to an individual optical media device and highly secure. Recreation of the private key can only be effectuated using the original optical medium (as in track 13B in FIG. 1). This eliminates the need to resort to physical protection methods as is required with other media types that are used to store private keys. This method and device allows low cost implementation of PKI data security when the keys are compared electronically by an access device that completes the security handshaking at three levels, i.e., the key pair plus the access device that matches the keys. There is no need for the expensive overhead of conventional smart cards, which require a microprocessor capability in each card to retrieve the private key stored within the smart card.

A chip within a smart card could also be used to make the necessary challenge-response comparison to validate the authentication of a key pair recorded on a recording medium device. In one current embodiment, the private key is encrypted with the hash code based on the analog characteristics of the medium itself.

By encrypting the private key with a hash code based on the recording medium characteristics the decryption and challenge response functions can take place in a much more powerful microprocessor. This can enable a much more secure and low cost data encryption system with security handshaking.

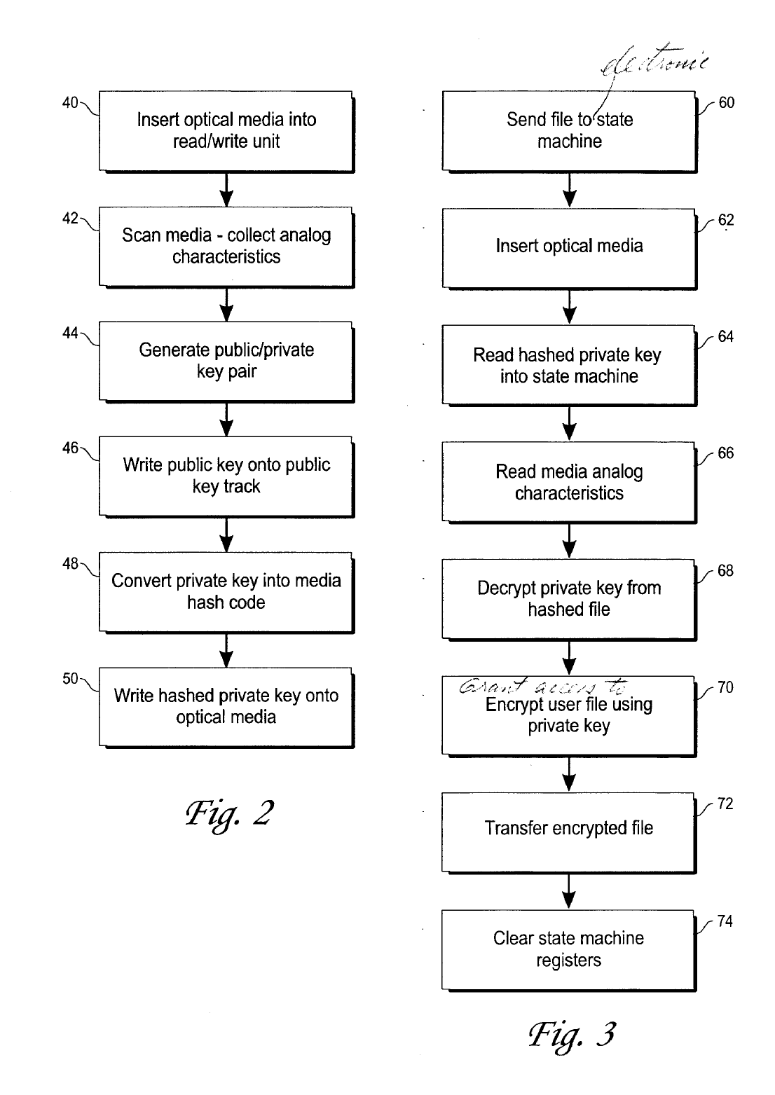

With reference to the flow chart of FIG. 3 for the encryption of data, a file is sent to the electronic state machine in step 30. In step 62 an optical recording medium is inserted into the read/write machine. In step 64 a hashed private key is read into the electronic state machine. In step 66 the analog media characteristics are read by the read/write device. This allows decryption of the private key from the hashed file in step 68. Once the private key is available to the user file, it is introduced into the electronic state machine in step 60, which gives access to an algorithm for encryption via the private key in step 70. The encrypted file is then transferred from the electronic state machine in step 72. In step 74 the state machine registers are cleared, allowing the elimination of the traces of the private key from the state machine.

What is claimed is:

1. A method comprising:
a) generating a security handshaking data pair;
b) storing a first member of the data pair on an optical recording medium; and
c) storing a second member of a data pair on a medium as a hash code, said hash code derived from analog properties of said optical recording medium.

2. The method of claim 1, further defined by storing the second member on the same medium as the first member.

3. The method of claim 1, further defined by storing the second member in the electronic access device.

4. The method of claim 1, wherein said first member of the data pair include at least two different types of optical analog signal characteristics.

5. The method of claim 4, wherein said optical signal characteristics are specific to a known location on said optical media.

6. An optical media data storage device comprising:
a plurality of tracks capable of storing optical data;
a public encryption key stored on a public track on said optical media; and
a hashed private key stored on a private track on said optical media, wherein said hashed private key is a private key converted into a private key hash code using analog signal characteristics of an optical media on the device.

7. The device of claim 6, wherein said optical media data storage device is an optical card.

8. The device of claim 6, wherein said analog signal characteristics include at least two different types of analog signal characteristics.

9. A method to encrypt data comprising:
sending a file to a read/write unit;
inserting an optical media into the read/write unit, said optical media device including a data track storing a hashed private key, wherein said hashed private key is a private key converted into a private key hash code using analog signal characteristics of an optical media device;
reading the hashed private key into state machine registers of a state machine on the read/write unit;
reading analog signal characteristics using the read/write unit;
decrypting, using said state machine, a non-hashed private key; and
using said non-hashed private key to encrypt said file.

10. The method of claim 9, wherein inserting optical media includes inserting an optical card.

11. The method of claim 9, wherein read analog signal characteristics includes reading optical signal characteristics include at least two different types of analog signal characteristics.

12. The method of claim 9 further including a final step of clearing said state machine registers.
